(19) United States
(12) Patent Application Publication
(10) Pub. No.: US 2007/0236934 A1
(43) Pub. Date: Oct. 11, 2007

(54) Illumination system and display device

(75) Inventors: Ya-Hsien Chang, Hong Kong (CN); Huajun Peng, Hong Kong (CN); Lap-Wai Leung, Hong Kong (CN); Geoffrey Wen Tai Shuy, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Company Limited, Hong Kong (CN)

(21) Appl. No.: 11/393,689

(22) Filed: Mar. 31, 2006

(51) Int. Cl. F21V 29/00

(52) U.S. Cl. 362/294

(57) ABSTRACT

An illumination system includes an elongate substrate, a plurality of unlensed light emitting diode (LED) chips mounted on the substrate along the length of the substrate, and a substantially transparent outer packaging for encapsulating the plurality of LED chips.

### FIELD OF THE INVENTION

The present relates to an illumination system for use in a display device and to a display device using the illumination system.

### BACKGROUND OF THE INVENTION

Linear illumination systems are desirable, especially in the backlighting systems for visual display devices such as monitors. Various existing devices and methods include those of U.S. Pat. No. 6,450,664 entitled “Linear illumination unit having plurality of LEDs” and issued to William Kelly on Sep. 17, 2002, U.S. Pat. No. 6,840,646 entitled “Illumination system and display device” and issued to Cornelissen, et al. on Jan. 11, 2005, and U.S. Pat. No. 6,866,398 entitled “Flexible rod light device formed of chip on board based LED lamps and manufacturing method thereof” and issued to Yuan Lin on Mar. 15, 2005, which use electronic illumination means including LED devices. However such illumination units may be generally large, which may be inconvenient or cumbersome in some applications.

It is an object of the present invention to provide an illumination system or a display device, which overcomes at least some of the deficiencies exhibited by those of the prior art.

### SUMMARY OF THE INVENTION

According to an aspect of the present invention, an illumination system includes an elongate substrate, a plurality of unlensed light emitting diode (LED) structures mounted on the substrate along the length of the substrate, and a substantially transparent outer packaging for encapsulating the plurality of LED chips.

According to a second aspect of the present invention, an illumination system includes an elongate substrate made of thermal conductive material, a plurality of unlensed light emitting diode (LED) chips mounted on the substrate along the length of the substrate, and a substantially transparent outer packaging for encapsulating the plurality of LED chips and being configured to form an optical lens for confining light emissions from the plurality of LED chips.

According to a third aspect of the present invention, in a process for producing an illumination system, an elongate substrate is firstly provided. A plurality of unlensed light emitting diode (LED) chips are then mounted on the substrate along the length of the substrate. Afterwards, a substantially transparent outer packaging is molded for encapsulating the plurality of LED chips.

According to a further aspect of the present invention, a liquid crystal display, includes a backlight unit, and the backlight unit has an elongate substrate made of thermal conductive material, a plurality of unlensed light emitting diode (LED) chips mounted on the substrate along the length of the substrate, and a substantially transparent outer packaging for encapsulating the plurality of LED chips and being configured to form an optical lens for confining light emissions from the plurality of LED chips.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

FIG. 1 is a perspective view illustrating part of a first exemplary illumination system embodiment of the present invention;

FIG. 2 is a plan view of the system of FIG. 1;

FIG. 3 is a perspective view illustrating part of the system of FIG. 1;

FIG. 4 is a cross section view illustrating part of the system of FIG. 1;

FIG. 5 is a perspective view illustrating part of a second exemplary illumination system embodiment of the present invention;

FIG. 6 is a perspective view illustrating part of a third exemplary illumination system embodiment of the present invention; and

FIG. 7 is a flow chart illustrating step-by-step a process of fabricating an exemplary illumination system embodiment of the present invention.

### DETAILED DESCRIPTION

FIG. 1 illustrates an exemplary illumination system embodiment 100 of the present invention. The system 100 firstly has an elongate substrate 101 with an elongate groove 103 created therein. The direction along the length of the substrate, the linear direction, is shown as the z axis in FIG. 1.

The groove 103 extends through a substantial length of the substrate 101 and has a pair of inclining slopes 105a, 105b extending from a substantially flat bottom surface 107 outwardly and ending at a pair of edges 109a, 109b, which are substantially parallel to the bottom surface 107.

The system 100 further includes unpackaged or unlensed semi-conductor LED chips 111, which are substantially linearly mounted on the bottom surface 109 along z axis and which emit light diverging approximately equally in all directions around the centerline of propagation (y). Because the LED chips 111 are unlensed, the viewing angle is approximately 120 degrees. However lensed LEDs having a viewing angle greater than 60 degrees may also be used. Since the unlensed LED chips 111 are semiconductor chips, they are mounted much more densely than has previously been the case and in this embodiment the density is approximately 25 per cm, with typical chip sizes of 0.25 mm square.

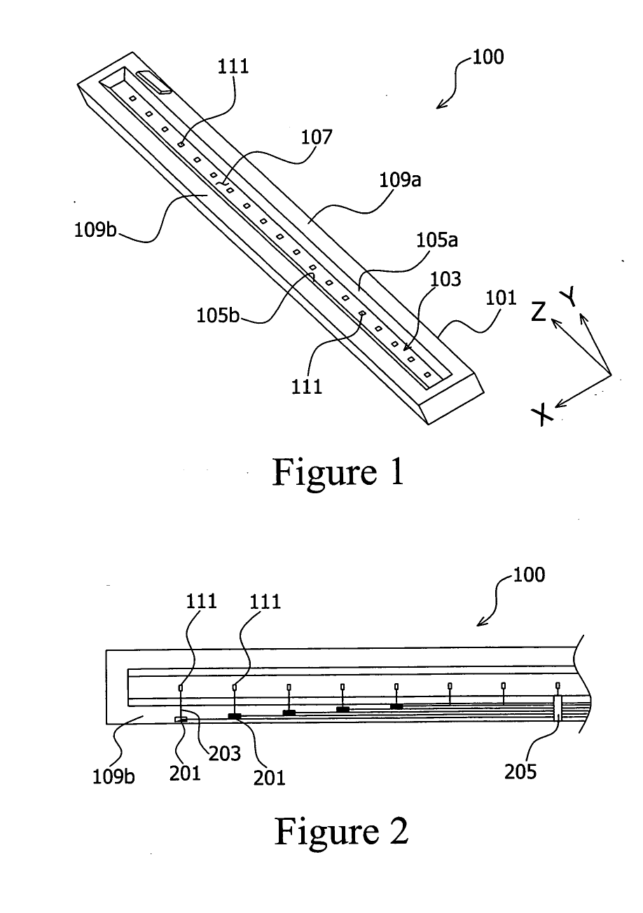

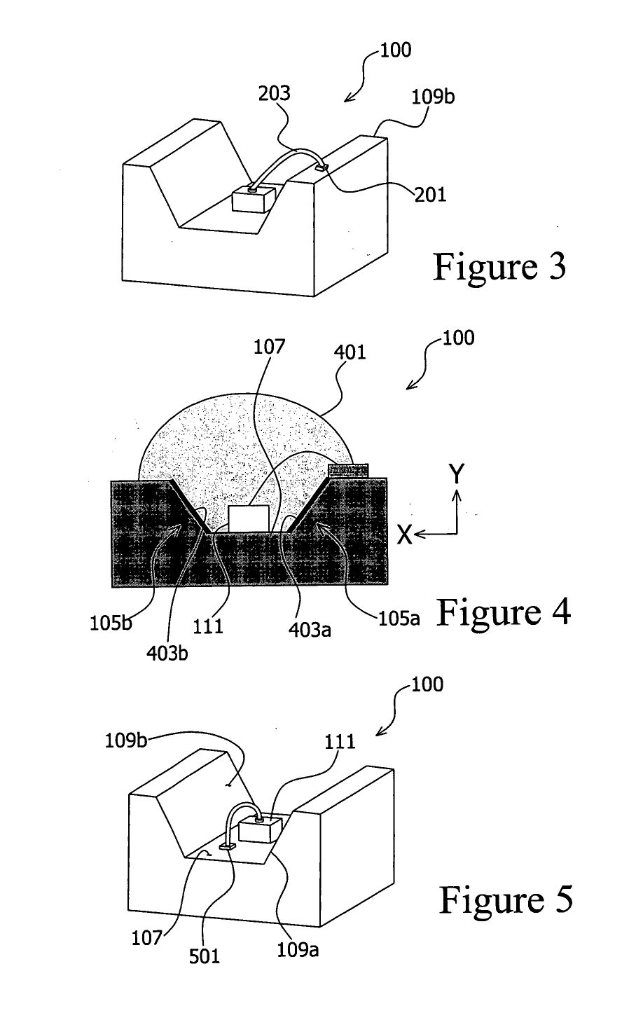

As shown in FIGS. 2-4, a plurality of electrodes 201 are provided on an edge 109b of the substrate 101, and each electrode 201 is electrically connected to a respective LED chip 111 through a wire 203 by using wire bonding technology. Furthermore, the electrodes 201 are connected to a centralized LED driver 205, which is electrically connected to a power source (now shown) and which drives the LED chips 111. The arrangement of the electrodes 201 and the centralized LED driver 203 may further make the system 100 more compact as compared to conventional designs.

As shown in FIG. 4, the system 100 further includes an outer packaging 401 encapsulating the LED chips 111. The packaging 401 is formed by filling the groove 103 with a continuous length of substantially transparent materials for example, epoxy or resin. The epoxy lens is molded such that the packaging 401 exhibits a shape of an optical lens as shown in FIG. 4. The system 100 also includes dielectric reflective films 403a, 403b coated on the inclining slopes 105a, 105b respectively. The optical lens 401 and the reflective films 403a, 403b function to focus the divergence of the light emissions of the LED chips 111 in the xy plane so as to obtain a narrow bright line of illumination as required. A dielectric reflective film (not shown) can also be coated on the bottom surface 107 to improve the optical efficiency of the system 100. Furthermore, patterned metal layer (not shown) can be coated atop the bottom surface 107 and or the slopes 105a, 105b but under the reflective films for providing electrical connections between the LED chips 111 and the respective electrodes 201.

In addition, diffuser components can be added to the epoxy lens 401 to improve uniformity of the light emissions of the system 100. Alternatively, phosphor powders can be added to the epoxy lens 401 for downward conversion purpose such that the system 100 may emit lights of different wavelength(s) or of different colors in a human being's perception.

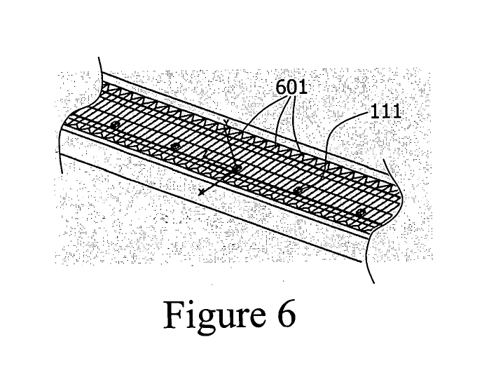

In a second exemplary embodiment of the present invention as shown in FIG. 5, electrodes, connected to the respective LED chips 111, are provided on the bottom surface 107 by wire bonding and connected to external electrical connections (not shown) through patterned metal layer (not shown) on the slopes 109a, 109b and/or the bottom surface 107.

In a third exemplary embodiment of the present invention as shown in FIG. 6, a plurality of top prisms 603, made of acrylic or polyethylene terephthalate and having top angle of approximately 80-110 degrees and pitch of 50-100 um in an exemplary embodiment, are provided atop the outer packaging (not shown in FIG. 6) for confining the divergence of the light emissions of the LED chips 111 in the yz plane.

Furthermore, in the various embodiment described thereabove, the substrate can be made of thermal conductive materials, for example, metal-core printed circuit board or ceram. Thereby, the illustration system may exhibit a relatively low thermal resistance and an improved heat dissipation performance. The use of thermal conductive material in the substrate, atop which the LED chips are directly mounted, may further make the illumination system more compact as compared to conventional design, which uses heat sink or other thermal dissipation mechanisms. This may also simply the fabrication process.

In addition, the above described illumination system can used as a backlight illumination system in various display devices, for example, laptop monitors, and so on.

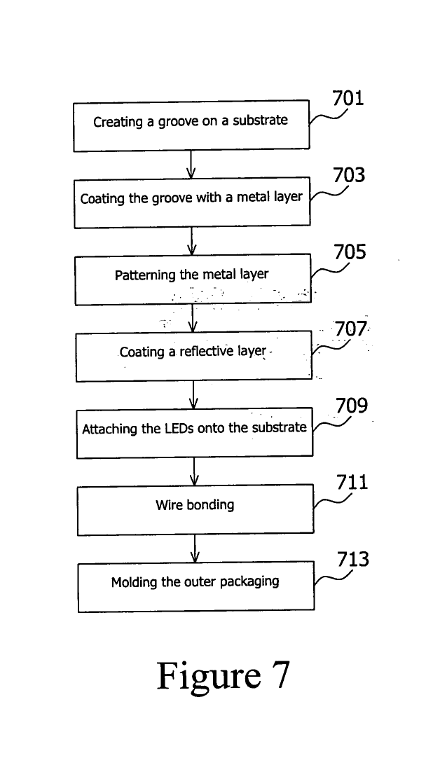

As shown in FIG. 7, in a process of fabricating an illumination system illustrated in FIG. 1, 5 or 6, in step 701, firstly an elongate substrate of thermal conductive materials, for example, metal-core printed circuit board or ceramic materials, is provided, and a groove is created on the substrate along its length by, for example, molding. In an exemplary embodiment, the groove has a depth of not more than 1.5 mm. In addition, electrodes can be formed on the edge of the groove.

In step 703, a metal layer, for example, alumina or silver layer, of approximately 50 um is coated on the whole surface of the side wall and bottom surface of the groove.

In step 705, the metal layer is patterned to form electrical connections to the electrodes at the side and bottom surfaces of the groove.

In step 707, a dielectric layer is coated atop the patterned metal layer. The dielectric layer is designed to be a high reflective stack with at least two layers of a high a low reflective index respectively. Each reflective layer has a thickness of quarter-wavelength.

In step 709, a string of unlensed LED chips are bonded onto the bottom surface of the groove by, for example, using silver glue.

In step 711, the LED chips are electrically connected to the electrodes by wire bonding.

In step 713, the groove is filled with epoxy to form an outer packaging encapsulating the LED chips. The outer packaging can be configured to form an optical lens for confining light emissions. Prisms can also be formed atop the outer packaging by, for example, molding.

It will be understood that the invention disclosed and defined herein extends to all alternative combinations of two or more of the individual features mentioned or evident from the text or drawings. All of these different combinations constitute various alternative aspects of the invention The foregoing describes an embodiment of the present invention and modifications, obvious to those skilled in the art can be made thereto, without departing from the scope of the present invention.

Although the invention is illustrated and described herein as embodied, it is nevertheless not intended to be limited to the details described, since various modifications and structural changes may be made therein without departing from the spirit of the invention and within the scope and range of equivalents of the claims.

Furthermore, it will be appreciated and understood that the words used in this specification to describe the present invention and its various embodiments are to be understood not only in the sense of their commonly defined meanings, but also to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result, without departing from the scope of the invention.

What is claimed is:

1. An illumination system, comprising:
an elongate substrate;
a plurality of unlensed light emitting diode (LED) chips mounted on the substrate along the length of the substrate; and
a substantially transparent outer packaging for encapsulating the plurality of LED chips.

2. The illumination system of claim 1, wherein the plurality of LED chips are arranged in a substantially linear direction along which the substrate extends.

3. The illumination system of claim 1, wherein the substrate is made of thermal conductive material.

4. The illumination system of claim 3, wherein the substrate is a metal-core printed circuit board.

5. The illumination system of claim 3, wherein the substrate is made of ceramic material.

6. The illumination system of claim 1, wherein substrate includes an elongate groove, and wherein the plurality of LED chips are mounted in the groove.

7. The illumination system of claim 6, wherein the groove includes a pair inclining slopes extending outwardly from a bottom of the groove.

8. The illumination system of claim 7, further comprising a reflector attached to at least one of the slopes and the bottom.

9. The illumination system of claim 8, wherein the reflector is formed by coating a metal layer on the at least one of the slopes and the bottom.

10. The illumination system of claim 9, wherein the groove is configured to confine a far field pattern of the light emissions.

11. The illumination system of claim 7, further comprising electrodes provided on the bottom of the groove or an edge of the groove where one of the slopes ends.

12. The illumination system of claim 1, wherein the outer packaging is made of resin.

13. The illumination system of claim 12, wherein the outer packaging includes phosphor for downward conversion.

14. The illumination system of claim 13, wherein the outer packaging includes diffuser materials.

15. The illumination system of claim 12, wherein the outer packaging is configured to form an optical lens for confining light emissions from the plurality of LED chips.

16. The illumination system of claim 12, wherein the outer packaging is configured to form a prism for confining light emissions from the plurality of LED chips.

17. The illumination system of claim 12, further comprising a centralized LED driver on the substrate and electrically connected to the LED chips for driving the same.

18. An illumination system, comprising
an elongate substrate made of thermal conductive material;
a plurality of unlensed light emitting diode (LED) chips mounted on the substrate along the length of the substrate; and
a substantially transparent outer packaging for encapsulating the plurality of LED chips and being configured to form an optical lens for confining light emissions from the plurality of LED chips.

19. A process for producing an illumination system, comprising:
Providing an elongate substrate;
Mounting a plurality of unlensed light emitting diode (LED) chips on the substrate along the length of the substrate; and
Molding a substantially transparent outer packaging for encapsulating the plurality of LED chips.

20. The process of claim 17, wherein the substrate is made of thermal conductive material.

21. A liquid crystal display, comprising a backlight unit, wherein the backlight unit includes
an elongate substrate made of thermal conductive material;
a plurality of unlensed light emitting diode (LED) chips mounted on the substrate along the length of the substrate; and
a substantially transparent outer packaging for encapsulating the plurality of LED chips and being configured to form an optical lens for confining light emissions from the plurality of LED chips.
